(19) United States
(12) Patent Application Publication
(10) Pub. No.: US 2018/0177029 A1
(43) Pub. Date: Jun. 21, 2018

(54) VOICE-CONTROLLED LIGHT BULB

(71) Applicant: Pilot, Inc., City of Industry, CA (US)

(72) Inventor: Calvin Shiening Wang, City of Industry, CA (US)

(21) Appl. No.: 15/599,674

(22) Filed: May 19, 2017

Related U.S. Application Data
(63) Continuation-in-part of application No. 15/383,148, filed on Dec. 19, 2016.

(51) Int. Cl. H05B 37/02; G10L 17/00; F21V 23/04; G10L 15/20

(52) U.S. Cl. CPC H05B 37/0236; G10L 15/20; F21V 23/0442; G10L 17/005

(57) ABSTRACT

A voice-activated or voice-controlled light bulb fits into a standard light socket and detects, with a microphone, commands spoken by a user. A processor in the light bulb, executing instructions stored in a memory of the light bulb, interprets the detected command, identifies an action associated with the detected command, and executes the action. In some embodiments, the light bulb transmits a signal to other light bulbs to cause the other light bulbs to execute the same action.

### CROSS-REFERENCE TO RELATED APPLICATIONS

This application is a continuation-in-part of U.S. patent application Ser. No. 15/383,148, entitled “Voice-Activated Vehicle Lighting Control Hub” and filed on Dec. 19, 2016, which is incorporated herein by reference in its entirety for all purposes.

### FIELD OF THE DISCLOSURE

The present disclosure relates to systems for controlling the operation of light bulbs, and more particularly to systems for providing hands-free control of the operation of such light bulbs.

### BACKGROUND

Automotive vehicles are traditionally equipped with external lighting, including headlights and taillights, for the safety of those both inside and outside of the vehicle. For example, headlights allow a vehicle operator to see along the vehicle's path of travel and avoid obstacles in that path, while both headlights and taillights make the vehicle more visible and noticeable to persons outside of the vehicle (including operators of other vehicles). Many other types of lights may be installed in or on a vehicle, including for example external fog lamps, grill lights, light bars, beacons, and flashing lights, and internal dome lights, reading lights, visor lights, and foot-well lights. These and other types of lights may be installed in a vehicle as manufactured or as an aftermarket addition to or modification of the vehicle. Such lights may be utilitarian (e.g. flashing lights on an emergency vehicle, or spotlights for illuminating a work area near the vehicle) or decorative (e.g. neon underbody lights, internal or external accent lights).

Additionally, lights bulbs are used in numerous applications to provide light, including in houses and other buildings. Such light bulbs may be installed, for example, in recessed light fixtures, in ceiling-mounted light bays, lamps, chandeliers, and fans, in wall-mounted light fixtures, in floor lamps, and in desk lamps. Light bulbs in light fixtures that are permanently installed are traditionally controlled by a switch that is hard-wired into the structure in which the light fixture is installed. Light bulbs in floor- and desk-mounted lamps and other portable light fixtures are traditionally controlled by a switch (usually a wall-mounted switch) that is provided directly on the light fixture. In some instances, portable light fixtures may be plugged into a power receptacle that is hard-wired to a switch, such that operation of the switch controls whether electricity flows to the power receptacle (and thus to any connected device, such as a portable light fixture).

Typical light switches are operated manually, by moving a physical switch from an on position to an off position or vice versa. Some specialty light fixtures use standard light bulbs but are equipped with a non-traditional switch, and the switches used to operate some traditional light fixtures that also use standard light bulbs are sometimes non-traditional as well. For example, some switches are equipped with a sound-activated switch that activates automatically upon detecting, for example, a clapping sound. Other switches are equipped with motion sensors that activate automatically when motion is detected. Still other switches are equipped with an electricity sensor and are configured to activate automatically when a normal power supply fails. Such switches control only the light fixtures or light bulbs to which they are wired. Still further switches may be operated by remote control, so that a user holding a remote control can cause the remote control to send a signal to the switch that causes the switch to activate (e.g. to a turn a light on or off).

### SUMMARY

Although specialty light switches have increased the convenience of light operation and reduced the need for a person to manually flip a switch to turn a light on or off, such switches maintain a level of inconvenience. For example, motion-activated switches may cause a light to illuminate upon sensing motion even when a user does not wish the light to illuminate. Switches with electricity sensors are useful for emergency lights that illuminate when the flow of electricity into a home or building ceases, but are not useful for everyday use. Switches operated by remote control allow a user to activate a switch from anywhere in proximity to the receiver (which may be mounted, for example, in a wall-mounted unit or in a unit mounted near the light fixture), but still require the user to manually push a button on the remote control, which may be easily misplaced or otherwise lost and which typically requires batteries that must be periodically recharged or replaced. Sound-activated switches avoid certain of these problems, but unless a light fixture is already equipped with a sound-activated switch, such a switch must be substituted for a wall-mounted switch or otherwise retrofitted for use with the light fixture, which is at best inconvenient but in some circumstances requires the services of an electrician, and in other circumstances simply is not practical or feasible. Sound-activated switches are also limited to one specific operation (e.g. turning a light on or off).

Embodiments of the present disclosure advantageously provide a light bulb that can be installed in any standard light bulb socket and that can be controlled by voice commands. As a result, the present disclosure beneficially provides the ease and convenience of some of the non-traditional switches described above while avoiding the drawbacks of such switches. In particular, a user of embodiments of the present disclosure can control the operation of a light bulb in any light fixture simply by speaking an audible command, without physically interacting with a switch and while retaining complete control over when the light bulb turns on or off. With verbal commands, multiple possible operations of the light may be controlled. Additionally, embodiments of the present disclosure provide for all of the light bulbs in a room, home, or other space to be controlled by speaking a voice command to a single light bulb, which then transmits control signals to other lights bulbs. These and other advantages will be readily apparent from the remaining portions of this written description.

According to one embodiment of the present disclosure, a voice-activated light bulb comprises a light-emitting device; a processor; a microphone; a power adapter; and a memory storing instructions for execution by the processor. The instructions, when executed by the processor, cause the processor to detect a signal received from the microphone; analyze the detected signal to extract a vocal command; identify an action associated with the vocal command, the action related to the light-emitting device; and execute the action.

The voice-activated light bulb may further comprise a physical user interface. The memory may store additional instructions for execution by the processor that, when executed by the processor, further cause the processor to detect an input received at the physical user interface; and execute at least one additional instruction corresponding to the detected input. The voice-activated light bulb may further comprise a wireless transceiver. The memory may store additional instructions for execution by the processor that, when executed by the processor, further cause the processor to broadcast a signal, via the wireless transceiver, corresponding to the identified action. The voice-activated light bulb may further comprise at least one filter configured to remove unwanted frequency components from the signal received from the microphone. The light-emitting device may comprise at least one LED. The action may comprise one of turning on the light-emitting device, turning off the light-emitting device, dimming the light-emitting device, brightening the light-emitting device, causing the light-emitting device to illuminate for a specified amount of time, causing a change in a color of light emitted by the light-emitting device, causing the light-emitting device to flash in a predetermined sequence, and causing the light-emitting device to pulse to a beat.

According to another embodiment of the present disclosure, a voice-controlled lighting system comprises at least one controllable light bulb and a voice-controlled light bulb. The at least one controllable light bulb comprises a first light-emitting device; a first processor; a first wireless transceiver; and a first memory. The first memory stores first instructions for execution by the first processor. The voice-controlled light bulb comprises a second light-emitting device; a second processor; a microphone; a second wireless transceiver; and a second memory, the second memory storing second instructions for execution by the second processor. The second instructions, when executed by the second processor, cause the second processor to detect a signal received from the microphone; analyze the detected signal to extract a vocal command; identify an action associated with the vocal command; transmit a signal, via the second wireless transceiver, to the at least one controllable light bulb, the signal corresponding to the identified action; and execute the action.

The first instructions, when executed by the first processor, may cause the first processor to receive the transmitted signal from the voice-controlled light bulb via the first wireless transceiver; determine the action to which the broadcast signal corresponds; and execute the action. The at least one controllable light bulb may comprise a first user interface, and the voice-controlled light bulb may comprise a second user interface. Each of the first and second user interfaces may comprise a physical button or switch. Simultaneous activation of the first user interface and the second user interface may causes at least one of the first processor and the second processor to execute instructions for establishing a communication channel between the controllable light bulb and the voice-controlled light bulb. At least one of the first and second light emitting devices may comprises at least one LED. The at least one of the first and second light emitting devices may comprise a plurality of LEDs, and the plurality of LEDs may comprise LEDs of different colors. The first memory may store additional first instructions for execution by the first processor that, when executed by the first processor, further cause the first processor to transmit a confirmation signal to the voice-controlled light bulb via the first wireless transceiver, the confirmation signal confirming that the action was executed.

According to still another embodiment of the present disclosure, a light bulb comprises a housing and a base. The housing comprises at least one transparent or translucent portion, and contains a light-emitting device configured to emit light through the at least one transparent or translucent portion; a microphone; a processor; and a memory storing instructions for execution by the processor. The instructions, when executed by the processor, cause the processor to detect a signal received from the microphone; analyze the detected signal to extract a vocal command; identify an action associated with the vocal command; and execute the action. The base is secured to a bottom portion of the housing, comprises external threads, and is adapted to secure the housing to a standard light socket.

The housing may further contain a wireless transceiver, and the memory may store additional instructions for execution by the processor that, when executed by the processor, further cause the processor to broadcast a signal corresponding to the identified action via the wireless transceiver. The housing may further contain a wireless transceiver, and the memory may store additional instructions for execution by the processor that, when executed by the processor, further cause the processor to transmit a signal, via the wireless transceiver, for causing an external speaker to provide verbal feedback regarding the vocal command or the action. The light-emitting device may comprise a plurality of LEDs. Identifying the action associated with the vocal command may comprise searching a look-up table.

The housing further contains a wireless transceiver, and the memory may store additional instructions for execution by the processor that, when executed by the processor, further cause the processor to receive a transmitted command via the wireless transceiver; and execute the transmitted command. The memory may store additional instructions for execution by the processor that, when executed by the processor, further cause the processor to receive a plurality of transmitted commands via the wireless transceiver; compare at least a portion of the plurality of transmitted commands to each other; identify, based on the comparison, one of the plurality of transmitted commands that has priority over the remainder of the plurality of transmitted commands; and execute the identified one of the plurality of transmitted commands.

The terms “memory,” “computer-readable medium” and “computer-readable memory” are used interchangeably and, as used herein, refer to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a voice-activated control hub according to one embodiment of the present disclosure;

FIG. 2 is a flowchart of a method according to another embodiment of the present disclosure;

FIG. 3 is a block diagram of a voice-activated control hub and associated receiver according to a further embodiment of the present disclosure;

FIG. 4 is a flowchart of a method according to yet another embodiment of the present disclosure;

FIG. 5 is a flowchart of a method according to still another embodiment of the present disclosure;

FIG. 6 is a block diagram of a voice-activated light bulb according to one embodiment of the present disclosure; and

FIG. 7 is a flowchart of a method of using a voice-activated light bulb according to another embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

Many passenger vehicles, as manufactured, have one switch or dial that controls the headlights, taillights, and other external lights, as well as separate switches for each of the car's interior lights (or for groupings thereof). As a result, a vehicle operator may need to turn on the vehicle's external lights with one hand and using a first switch, then turn on one internal light with another hand and using a second switch located apart from the first switch, then turn on a second internal light with either hand but using a third switch located apart from the first and second switches. If aftermarket lighting has been installed on the vehicle, then such lighting may be controlled by one or more additional switches. As a result, the operation of the vehicle's lighting is decentralized and generally inconvenient for the operator. Indeed, using present systems, an operator wishing to activate or deactivate a light must remove at least one hand from the steering wheel, then divert his or her attention from outside the vehicle to inside the vehicle to locate and activate the appropriate switch for the light in question. Depending on the location of the switch for the light at issue, the operator may have to contort his or her body to reach the desired switch from the driver's seat, or stop the vehicle, exit the vehicle, and access the light switch in question from another door or other access point of the vehicle. Beyond inconveniencing the operator, these steps may present safety concerns to the extent they result in the operator diverting his or her attention from the road or other drive path of the vehicle.

Still further, aftermarket lighting may require stringing a control wire from the lighting device itself (which may be outside the vehicle) to the area surrounding the driver. This may require time-consuming installation, modification of existing vehicle components to create a path for the wire, and/or aesthetically displeasing arrangements (e.g. if the wire in question is visible from the passenger cabin or on the exterior of the vehicle).

The present disclosure provides a solution for the problems of and/or associated with decentralized vehicle lighting control, distracted driving due to light operation, difficulty of accessing light switches from the driver's seat, and wired control switch installation.

According to one embodiment of the present disclosure, a voice-activated lighting control hub comprises a voice acquisition unit comprising a microphone; a speech recognition unit comprising a processor and a computer-readable memory storing instructions for execution by the processor; a wireless communication unit; and a power management unit configured to provide power to at least the speech recognition unit in a first low-power sleep mode and in a second operational mode. The instructions, when executed by the processor, cause the processor to: recognize an input; exit the first low-power sleep mode and enter the second operational mode; process instructions received via the voice acquisition unit; generate a signal responsive to the processed instructions; and transmit the signal via the wireless communication unit.

The voice-activated lighting control hub may further comprise a user interface and a speaker. The input may be received via the user interface. The instructions, when executed by the processor, may further cause the processor to cause the speaker to play a prompt in response to the input. The instructions, when executed by the processor, may further cause the processor to cause the speaker to describe a present status of a lighting device after transmission of the signal via the wireless communication unit. The signal may correspond to a command to change a status of a lighting device. The status may correspond to one of a power state of the lighting device, a color of light generated by the lighting device, a flashing sequence of the lighting device, a position of the lighting device, an orientation of the lighting device, and an intensity of light generated by the lighting device. The voice acquisition unit may further comprise an analog-to-digital converter. The power management unit may comprise a 12-volt adapter for connection of the voice-activated lighting control hub to a 12-volt power receptacle. The user interface may comprise a touch key. The user interface may comprise an LED indicator, and the instructions, when executed by the processor, may further cause the processor to provide an indication, via the LED indicator, that the voice-activated lighting control hub is in the second operational mode.

According to another embodiment of the present disclosure, a method of controlling a lighting device of a vehicle using a voice-activated lighting control hub comprises: prompting, via a speaker and based on a first signal from a processor, a user to provide a first input; receiving, via a microphone, the first input from the user; identifying a lighting device corresponding to the first input; providing, via the speaker and based on a second signal from the processor, at least one option for the lighting device; receiving, via the microphone, the option selection; generating a control signal based on the option selection; transmitting the control signal via a wireless transceiver; and receiving, via the wireless transceiver, a confirmation signal in response to the control signal.

The prompting and the providing may comprise playing a computer-generated voice via the speaker. The identifying may comprise identifying a selected lighting device from among a plurality of lighting devices controllable using the voice-activated lighting control hub. The at least one option may correspond to one or more of a power state of the lighting device, a color of light generated by the lighting device, a flashing sequence of the lighting device, a position of the lighting device, an orientation of the lighting device, and an intensity of light generated by the lighting device. The method may further comprise: initiating a countdown timer after receipt of the confirmation signal; and entering a low-power state if another input is not received via the microphone prior to expiration of the countdown timer. The method may further comprise: receiving an initial input via a user interface; and exiting a low-power state in response to the initial input. The user interface may comprise a touch key.

According to yet another embodiment of the present disclosure, a voice-activated control system for a vehicle comprises a hub and a receiver. The hub comprises a processor; a computer-readable memory storing instructions for execution by the processor; a voice acquisition unit comprising a microphone; and a first wireless transceiver. The receiver comprises a microcontroller; a second wireless transceiver; and a lighting device interface. The instructions for execution by the processor, when executed by the processor, cause the processor to receive, via the voice acquisition unit, a verbal instruction to adjust a setting of a lighting device connected to the lighting device interface; generate a control signal, based on the verbal instruction, for causing the setting of the lighting device to be adjusted; and cause the first wireless transceiver to transmit the control signal to the second wireless transceiver.

The hub may further comprise a speaker. The instructions for execution by the processor, when executed by the processor, may further cause the processor to generate a second signal for causing the speaker to play a computer-generated voice that identifies at least one option for the lighting device. The at least one option may correspond to one or more of a power state of the lighting device, a color of light generated by the lighting device, a flashing sequence of the lighting device, a position of the lighting device, an orientation of the lighting device, and an intensity of light generated by the lighting device. The microcontroller may comprise a second processor and a second computer-readable memory storing second instructions for execution by the second processor, and the second instructions, when executed by the second processor, may cause the second processor to receive the control signal via the second wireless transceiver; send, via the lighting device interface, a command signal based on the control signal; and transmit a confirmation signal via the second wireless transceiver. The confirmation signal may comprise a present status of a lighting device connected to the lighting device interface.

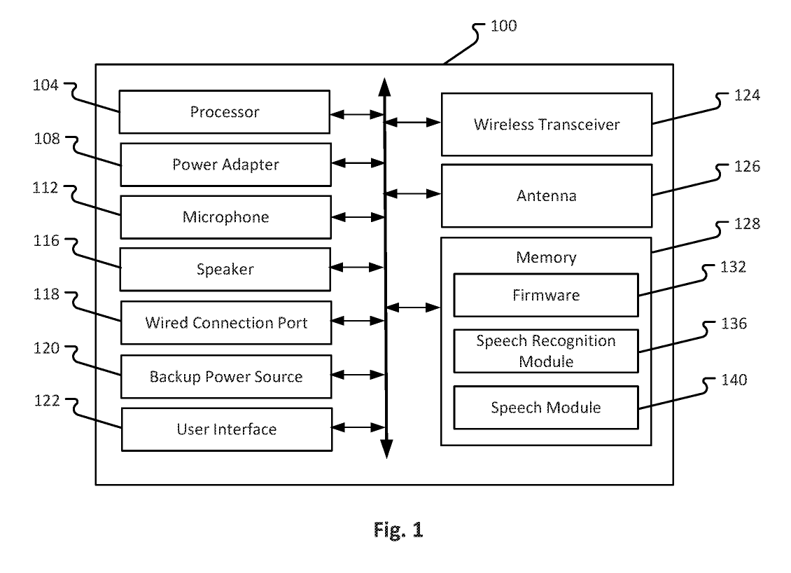

Referring first to FIG. 1, a voice-activated lighting control hub 100 according to an embodiment of the present disclosure comprises a processor 104, a power adapter 108, a microphone 112, a speaker 116, one or more wired connection ports 118, a backup power source 120, a user interface 122, a wireless transceiver 124 coupled to an antenna 126, and a memory 128.

The processor 104 may correspond to one or multiple microprocessors that are contained within a housing of the voice-activated lighting control hub 100. The processor 104 may comprise a Central Processing Unit (CPU) on a single Integrated Circuit (IC) or a few IC chips. The processor 104 may be a multipurpose, programmable device that accepts digital data as input, processes the digital data according to instructions stored in its internal memory, and provides results as output. The processor 104 may implement sequential digital logic as it has internal memory. As with most known microprocessors, the processor 104 may operate on numbers and symbols represented in the binary numeral system.

The power adapter 108 comprises circuitry for receiving power from an external source, such as a 12-volt automobile power receptacle, and accomplishing any signal transformation, conversion or conditioning needed to provide an appropriate power signal to the processor 104 and other components of the hub 100. For example, the power adapter 108 may comprise one or more DC to DC converters for converting the incoming signal (e.g., an incoming 12-volt signal) into a higher or lower voltage as necessary to power the various components of the hub 100. Not every component of the hub 100 necessarily operates at the same voltage, and if different voltages are necessary, then the power adapter 108 may include a plurality of DC to DC converters. Additionally, even if one or more components of the hub 100 do operate at the same voltage as the incoming power signal (e.g. 12 volts), the power adapter 100 may condition the incoming signal to ensure that the power signal(s) being provided to the other components of the hub 100 remains within a specific tolerance (e.g. plus or minus 0.5 volts) regardless of fluctuations in the incoming power signal. In some embodiments, the power supply 108 may also include some implementation of surge protection circuitry to protect the components of the hub 100 from power surges.

The power adapter 108 may also comprise circuitry for receiving power from the backup power source 120 and carrying out the necessary power conversion and/or conditioning so that the backup power source 120 may be used to power the various components of the hub 100. The backup power source 120 may be used, for example, to power an uninterruptible power supply to protect against momentary drops in the voltage provided by the main power source.

The microphone 112 is used to receive verbal commands regarding control of one or more vehicle lighting systems. The microphone 112 may be any type of microphone suitable for detecting and recording verbal commands in a vehicle, where there may be high levels of ambient noise. The microphone 112 may be, for example, an electret microphone. The microphone 112 may also be a cardioid or other directional microphone, for limiting the detection of unwanted noise. The microphone 112 may comprise noise-cancelling or noise-filtering features, for cancelling or filtering out noises common to the driving experience, including such noises as passenger voices, air conditioning noises, tire noise, engine noise, radio noise, and wind noise. In some embodiments, the hub 100 may comprise a plurality of microphones 112, which may result in an improved ability to pick up verbal commands and/or to filter out unwanted noise.

In some embodiments, the microphone 112 is contained within or mounted to a housing of the hub 100, while in other embodiments the microphone 112 may be external to and separate from the hub 100, and connected thereto via a wired or wireless connection. For example, a microphone 112 may be plugged into a wired connection port 118 of the hub 100. Alternatively, the hub 100 may be configured to pair with an external microphone 112 using the wireless transceiver 124, via a wireless communication protocol such as Wi-Fi, Bluetooth®, Bluetooth Low Energy (BLE), ZigBee, MiWi, FeliCa, Weigand, or a cellular telephone interface. In this way, the microphone 112 may be positioned closer to the mouth of a user of the hub 100, where it can more readily detect verbal commands uttered by the user.

The speaker 116 is used by the hub 100 to provide information to a user of the hub 100. For example, if a user requests a status update on one or more lighting systems in a vehicle, the requested information may be spoken to the user by a computer generated voice via the speaker 116. As with the microphone 112, the speaker 116 may be contained within or mounted to a housing of the hub 100 in some embodiments. In other embodiments, however, the speaker 116 may be external to a housing of the hub 100, and may be connected thereto via a wired or wireless connection. For example, a wire (e.g. a USB cable or a 3.5 mm audio cable) may be used to connect the wired connection port 118 of the hub 100 to an input port of the vehicle in which the hub 100 is utilized, such that the hub 100 simply utilizes the speakers of the vehicle as the speaker 116. As another example, the wireless transceiver 124 may be used to connect to an infotainment system of the vehicle, or to a headset or earpiece worn by an operator of the vehicle, using a wireless communication protocol such as Wi-Fi, Bluetooth®, BLE, ZigBee, MiWi, FeliCa, Weigand, or a cellular telephone interface. In this manner, the speaker(s) of the vehicle infotainment system, or of the headset or earpiece worn by the operator, may be used as the speaker 116. In still other embodiments, the hub 100 may comprise both an in-housing speaker 116 and an ability to be connected to an external speaker 116, to provide maximum flexibility to a user of the hub 100.

The voice-activated lighting control hub 100 also comprises a backup power source 120. The backup power source 120 may be, for example, one or more batteries (e.g. AAA batteries, AA batteries, 9-volt batteries, lithium ion batteries, button cell batteries). The backup power source 120 may be used to power the hub 100 in a vehicle having no 12-volt power receptacle, or to provide supplemental power if the power obtained by the power adapter 108 from the external power source is insufficient.

A user interface 122 is further provided with the hub 100. The user interface allows a user of the hub 100 to “wake up” the hub 100 prior to speaking a verbal command into the microphone 112 of the hub 100. The user interface 122 may be in the form of a button, switch, sensor, or other device configured to receive an input, and/or it may be a two-way interface such as a touchscreen, or a button, switch, sensor, or other input device coupled with a light or other output device. The user interface 122 beneficially facilitates the placement of the hub in a low power or “sleeping” state when not in use. When a user provides an input via the interface 122, the hub 100 wakes up. One or both of a visual indication and an audio indication may confirm that the device is awake and ready to receive a command. For example, if the user interface 122 comprises a light, the light may illuminate or may turn from one color (e.g. red) to another (e.g. green). Additionally or alternatively, the processor 104 may cause the speaker 116 to play a predetermined audio sequence indicating that the hub 100 is ready to receive a command, such as “Yes, master?”. Once a user awakens the hub 100 by providing an input via the user interface 122, the hub 100 may remain awake for a predetermined period of time (e.g. fifteen seconds, or thirty seconds, or forty-five seconds, or a minute). The predetermined period of time may commence immediately after the hub 100 is awakened, or it may commence (or restart) once a command is received. The latter alternative beneficially allows a user to provide a series of commands without having to awaken the hub 100 by providing an input via the user interface 122 prior to stating each command.

The wireless transceiver 124 comprises hardware that allows the hub 100 to transmit and receive commands and data to and from one or more lighting devices (not shown), as well as (in some embodiments) one or both of a microphone 112 and/or a speaker 116 (e.g. in embodiments where the microphone 112 and/or speaker 116 may be external to and separate from the hub 100). The primary function of the wireless transceiver 124 is to interact with a wireless receiver or transceiver in communication with one or more lighting devices installed in or on the vehicle in which the hub 100 is being used. The wireless transceiver 124 therefore eliminates the need to route wiring from a lighting device (which may be on the exterior of the vehicle) to a control panel inside the vehicle and within reach of the vehicle operator, and further eliminates any aesthetic drawbacks of such wiring. Instead, the hub 100 can establish a wireless connection with a given lighting device using the wireless transceiver 124, which connection may be used to transmit commands to turn the lighting device's lights on and off, and/or to control other features of the lighting system (e.g. flashing sequence, position, orientation, color). As noted above, the wireless transceiver 124 may also be used for receiving data from a microphone 112 and/or for transmitting data to a speaker 116.

The wireless transceiver 124 may comprise a Wi-Fi card, a Network Interface Card (NIC), a cellular interface (e.g., antenna, filters, and associated circuitry), an NFC interface, an RFID interface, a ZigBee interface, a FeliCa interface, a MiWi interface, Bluetooth interface, a BLE interface, or the like.

The memory 128 may correspond to any type of non-transitory computer-readable medium. In some embodiments, the memory 128 may comprise volatile or non-volatile memory and a controller for the same. Non-limiting examples of memory 128 that may be utilized in the hub 100 include RAM, ROM, buffer memory, flash memory, solid-state memory, or variants thereof.

The memory 128 stores any firmware 132 needed for allowing the processor 104 to operate and/or communicate with the various components of the hub 100, as needed. The firmware 132 may also comprise drivers for one or more of the components of the hub 100. In addition, the memory 128 stores a speech recognition module 136 comprising instructions that, when executed by the processor 104, allow the processor 104 to recognize one or more commands in a recorded audio segment, which commands can then be carried out by the processor 104. Further, the memory 128 stores a speech module 140 comprising instructions that, when executed by the processor 104, allow the processor 104 to provide spoken information to an operator of the hub 100.

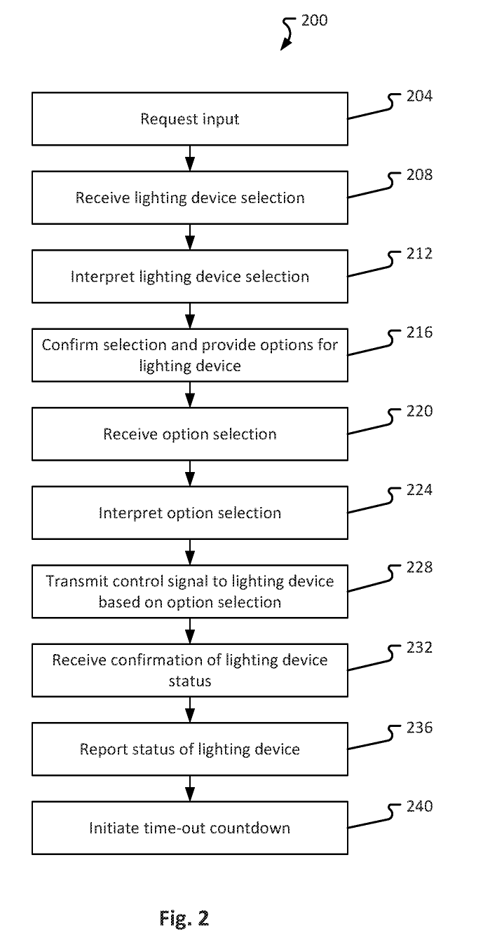

With reference now to FIG. 2, a voice-activated lighting control hub 100 according to the present disclosure may be operated according to a method 200. In the following description of the method 200, reference may be made to actions or steps carried out by the hub 100, even though the action or step is carried out only by a specific component of the hub 100.

After the hub 100 has received an input via the user interface 122 that causes the hub 100 to wake up out of a low-power, sleeping mode, the hub 100 requests input from a user (step 204). The request may be in the form of causing the speaker 116 to play a computer-generated voice asking, for example, “Yes, master?”. Other words or phrases may also be used, including, for example, “What would you like to do?” or “Ready.” In some embodiments, the request may be replaced or supplemented by a simple indication that the hub 100 is ready to receive a command, such as by changing the color of an indicator light provided with the user interface 122, or by generating an audible beep using the speaker 116.

The hub 100 receives a lighting device selection (step 208). The user makes a lighting device selection by speaking the name of the lighting device that the user would like to control. For example, the lighting device selection may comprise receiving and/or recording a lighting device name such as “accent light” or “light bar” or “driving lights.” The name of each lighting device controllable with the hub 100 may be preprogrammed by a manufacturer of the lighting device and transmitted to the hub 100 during an initial configuration/pairing step between the hub 100 and the lighting device in question, or the name of a lighting device may be programmed by the user during an initial configuration/pairing step between the hub 100 and the lighting device in question.

Upon receipt of the lighting device selection, the hub 100 interprets the lighting device selection (step 212). More specifically, the processor 104 executes the speech recognition module 136 to translate or otherwise process the verbal lighting device selection into a computer-readable input or instruction corresponding to the selected lighting device. Alternatively, the processor 104 may execute the speech recognition module 136 to compare the verbal lighting device selection with a prerecorded or preprogrammed set of lighting device names, identify a match, and select a computer-readable input or instruction corresponding to the matched lighting device.

Once the hub 100 has identified the selected lighting device, the hub 100, via the speaker 116, confirms the selected lighting device and presents to the user available options for that lighting device. More specifically, the processor 104 retrieves from the memory 128 information about the current status of the selected lighting device and the other available statuses of the selected lighting device, and causes the speaker 116 to play a computer-generated voice identifying the current status of the selected lighting device and/or the other available statuses of the selected lighting device. For example, if the user selects “accent light” in step 204, then the hub 100 may respond with “Yes, master. Accent light here. Do you want steady, music, flash, or rainbow?” Alternatively, if the user selects “headlights” in step 204, and the headlights are currently on, then the hub 100 may respond with “The headlights are on. Would you like high-beams?” or “You selected headlights. Would you like to activate high-beams or turn the headlights off?” As evident from these examples, the hub 100 may be programmed to adopt a conversational tone with a user (e.g. by using full sentences and responding to each command with an acknowledgment (e.g. “yes, master”) before requesting additional input. Alternatively, the hub 100 may be programmed only to convey information. In such an embodiment, the hub 100 may say, for example, “Accent light. Steady, music, flash, or rainbow?” or “Headlights on. High-beams or off?”

In some embodiments, obvious options (e.g. “on” or “off”) are not provided by the hub 100 at step 216, even though one or more such options may always be available. Also in some embodiments, the hub 100 may be programmed to automatically turn on any selected lighting device, so that a user does not have to select a lighting device and then issue a separate command to turn on that lighting device.

The hub 100 next receives an option selection (step 220). As with step 208, this occurs by receiving and/or recording, via the microphone 112, a verbal command from a user. For example, if the selected lighting device is the accent light and the provided options were steady, music, flash, and rainbow, the hub 100 may receive an option selection of “steady,” or of “music,” or of “flash,” or of “rainbow.” As noted above, in some embodiments, obvious options may not be explicitly provided to the user, and in step 220 the user may select such an option. For example, rather than select one of the four provided options (music, steady, flash, or rainbow), the user may say “off” or “change color.”

Once the hub 100 has received an option selection at step 220, the hub 100 interprets the option selection (step 224). As described above with respect to interpreting the lighting device selection in step 212, interpreting the option selection may comprise the processor 104 executing the speech recognition module 136 to translate or otherwise process the verbal option selection into a computer-readable input or instruction corresponding to the selected option. Alternatively, the processor 104 may execute the speech recognition module 136 to compare the verbal option selection with a prerecorded, preprogrammed, or otherwise stored set of available options, identify a match, and select a computer-readable input or instruction corresponding to the matched option.

In step 228, the hub 100 executes the computer-readable code or instruction identified in step 224, which causes the hub 100 to transmit a control signal to a particular lighting device based on the selected option. For example, if the command is “flash,” the hub 100 may transmit a wireless signal to a receiver in electronic communication with the accent light instructing the accent light to flash. If the command is “music,” the hub 100 may transmit a wireless signal to a receiver in electronic communication with the accent light instructing the accent light to pulse according to the beat of music being played by the vehicle's entertainment or infotainment system. If the command is “high beams” for the headlights, then the hub 100 may transmit a wireless signal to a receiver in electronic communication with the headlights, instructing the headlights to switch from low-beams to high-beams. The hub 100 may also be configured to recognize compound option selections. For example, the command may be “change color and flash,” which may cause the hub 100 to transmit a wireless signal to a receiver in electronic communication with the accent light that instructs the accent light to change to the next color in sequence and to begin flashing.

After transmitting a control signal to the selected lighting device corresponding to the selected option in step 228, the hub 100 waits to receive a confirmation signal from the lighting device (step 232). The confirmation signal may be a generic acknowledgment that a command was received and carried out, or it may be a more specific signal describing the current state of the lighting device (e.g. on, off, high-beam, low-beam, flashing on, flashing off, color red, color green, color purple, color blue, music, steady, rainbow).

In step 236, the hub 100 reports to the user the status of the lighting device from which the confirmation signal was received. As with other communications to the user, the report is provided in spoken format via the speaker 116 using a computer-generated voice. The report may be, for example, a statement similar to the command, such as “flashing” or “accent light steady.” Alternatively, the report may be more generic, such as “command executed.” In still another alternative, the report may give the present status of the lighting device in question, such as “the accent light is now red” or “the accent light is now green.” In some embodiments, the user may have the option to turn such reporting on or off, and/or to select the type of reporting the user desires to receive.

After reporting the status of the lighting device in step 236, the hub 100 initiates a time-out countdown (step 240). This may comprise initiating a countdown timer, or it may comprise any other known method of determining tracking when a predetermined period of time has expired. If the time-out countdown concludes without receiving any additional input from the user, then the hub 100 returns to its low-power sleeping mode. If the user does provide additional input before the time-out countdown concludes, then the hub 100 repeats the appropriate portion of the method 200 (e.g. beginning at step 208 if the additional input is a light device selection or at step 220 if the additional input is an option selection for the previously selected lighting device).

In some embodiments of the present disclosure, a voice-activated lighting control hub according to embodiments of the present disclosure may not include a user interface 122, but may instead constantly record and analyze audio received via the microphone 112. In such embodiments, the hub may be programmed to analyze the incoming audio stream for specific lighting device names or option selections, or to recognize a specific word or phrase (or one of a plurality of specific words of phrases) as indicative that a command will follow. The specific word or phrase may be, for example, a name of the hub 100 (e.g. “Control Hub”), or the name of a lighting device, such as “light bar,” or “accent light.” The word or phrase may be preprogrammed upon manufacture of the hub 100, or it may be programmable by the user. The word or phrase may be a name of the hub 100 (whether that name is assigned by the manufacturer or chosen by a user). When the hub 100 continuously analyzes incoming audio, the hub 100 may continuously record incoming audio (which may be discarded or recorded over once the audio has been analyzed and found not to include a command, or once a provided command has been executed), or may record audio only when a word or phrase trigger is detected.

According to alternative embodiments of the present disclosure, the hub 100 may be programmed or otherwise configured to receive and respond to audio commands. An audio command in such embodiments may include (1) an identification of the lighting device having a state that the commanding user would like to change; and (2) an identification of the change the user would like to make. This two-pronged format may not be needed or utilized where the hub 100 controls only one lighting device, and/or where the lighting device in question has only two possible states (e.g. on/off). However, if for example the hub 100 controls a plurality of lighting devices (e.g. fog lamps, underbody accent lights, and a roof-mounted light bar), and where one or more of the lighting devices may be controlled in more ways than just being turned on and off (e.g. by changing an intensity of a light of the lighting device, a direction in which the lighting device is pointed, an orientation of the lighting device, a flashing sequence of the lighting device, a color of the light emitted from the lighting device, a position of the lighting device (e.g. raised/lowered)), the two-pronged format for audio commands may be useful or even necessary.

In addition to receiving input intended for control of a lighting device, the voice-activated lighting control hub 100 may also be programmed to recognize audio commands regarding control of the hub 100 itself. For example, before the hub 100 can transmit commands to a lighting device, the hub 100 may need to be paired with or otherwise connected to the lighting device. The hub 100 may therefore receive commands causing the hub 100 to enter a discoverable mode, or causing the hub 100 to pair with another device in a discoverable mode, or causing the hub 100 to record connection information for a particular lighting device. Additionally, the hub 100 may be programmed to allow a user to record specific commands in his or her voice, to increase the likelihood that the hub 100 will recognize and respond to such commands correctly. Still further, the hub 100 may be configured to recognize commands to change a trigger word or phrase to be said by the user prior to issuing a command to the hub 100, or to record a name for a lighting device. As an alternative to programming conducted by speaking verbal commands to the hub 100, a user may program or otherwise configure the hub 100 using the user interface 122, particularly if the user interface 122 comprises a touchscreen adapted to display information via text or in another visual format.

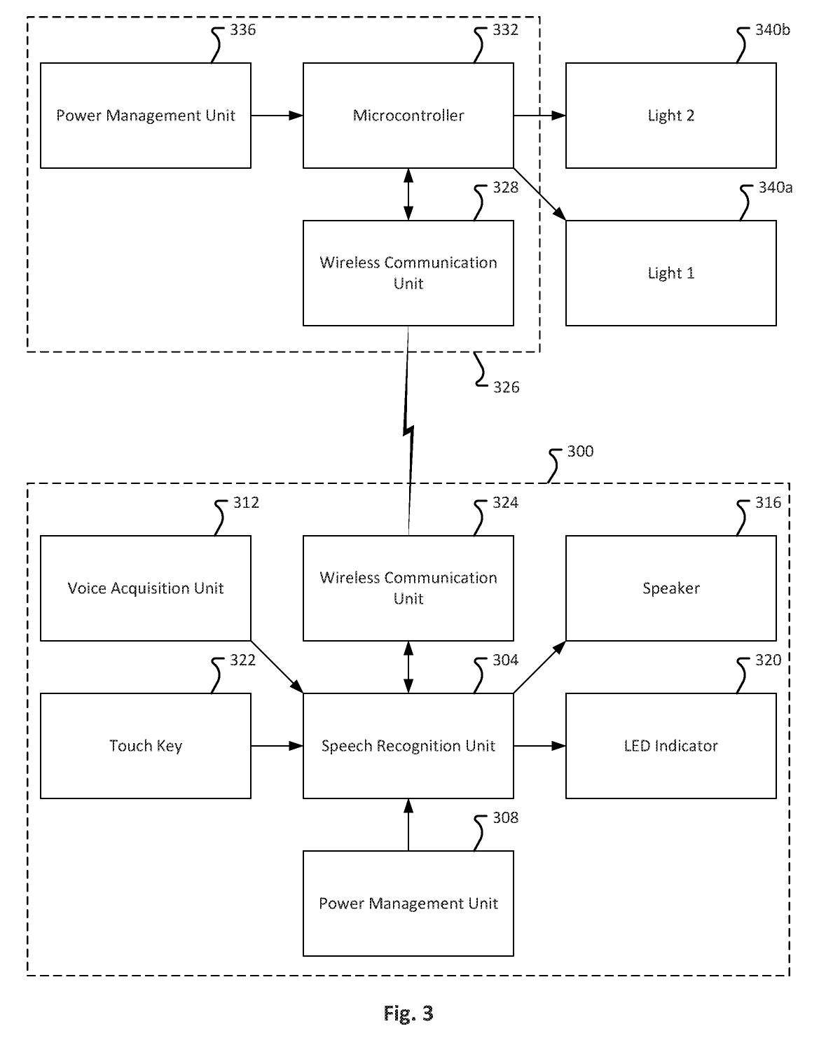

Turning now to FIG. 3, a voice-activated lighting control hub 300 according to yet another embodiment of the present disclosure comprises a speech recognition unit 304, a power management unit 308, a voice acquisition unit 312, a speaker 316, an LED indicator 320, a touch key 322, and a wireless communication unit 324. The voice-activated lighting control hub 300 communicates wirelessly with a receiver 326 that comprises a wireless communication unit 328, a microcontroller 332, and a power management unit 336. The receiver 326 may be connected (via a wired or wireless connection) to one or more lights 340a, 340b.

Speech recognition unit 304 may comprise, for example, a processor coupled with a memory. The processor may be identical or similar to the processor 104 described in connection with FIG. 1 above. Likewise, the memory may be identical or similar to the memory 128 described in connection with FIG. 1 above. The memory may store instructions for execution by the processor, including instructions for analyzing digital signals received from the voice acquisition unit 312, identifying one or more operations to conduct based on an analyzed digital signal, and generating and transmitting signals to one or more of the speaker 316, the LED indicator 320, and the wireless communication unit 324. The memory may also store instructions for execution by the processor that allow the processor to generate signals corresponding to a computer-generated voice (e.g. for playback by the speaker 316), for communication of information or of prompts to a user of the hub 300. The memory may further store information about the lights 340a, 340b that may be controlled using the hub 300.

The power management unit 308 handles all power-related functions for the hub 300. These functions include receiving power from a power source (which may be, for example, a vehicle 12-volt power receptacle; an internal or external battery; or any other source of suitable power for powering the components of the hub 300), and may also include transforming power signals to provide an appropriate output voltage and current for input to the speech recognition unit 304 (for example, from a 12-volt, 10 amp received power signal to a 5-volt, 1 amp output power signal), and/or conditioning an incoming power signal as necessary to ensure that it meets the power input requirements of the speech recognition unit 304. The power management unit 308 may also comprise a battery-powered uninterruptible power supply, to ensure that the output power signal thereof (e.g. the power signal input to the speech recognition unit 304) does not vary with fluctuations in the received power signal (e.g. during engine start if the power signal is received from a vehicle's 12-volt power receptacle).

The voice acquisition unit 312 receives voice commands from a user and converts them into signals for processing by the speech recognition unit 304. The voice acquisition unit 312 may comprise, for example, a microphone and an analog-to-digital converter. The microphone may be identical or similar to the microphone 112 described in connection with FIG. 1 above.

The speaker 316 may be identical or similar to the speaker 116 described in connection with FIG. 1 above. The speaker 316 may be used for playback of a computer-generated voice based on signals generated by the speech recognition unit 304, and/or for playback of one or more non-verbal sounds (e.g. beeps, buzzes, or tones) at the command of the speech recognition unit 304.

The LED indicator 320 and the touch key 322 provide a non-verbal user interface for the hub 300. The speech recognition unit 304 may cause the LED indicator to illuminate with one or more colors, flashing sequences, and/or intensities to provide one or more indications to a user of the hub 300. For example, the LED indicator may display a red light when the hub 300 is in a low power sleep mode, and may switch from red to green to indicate to a user that the hub 300 has awakened out of the low power sleep mode and is ready to receive a command. Indications provided via the LED indicator 320 may or may not be accompanied by playback of a computer-generated voice by the speaker 316. For example, when the hub 300 wakes up out of a low power sleep mode, the LED indicator may change from red to green and the speech recognition unit 304 may cause a computer-generated voice to be played over the speaker 316 that says “yes, master?” As another example, the LED indicator 320 may flash a green light when it is processing a command, and may change from a low intensity to a high intensity when executing a command.

The touch key 322 may be depressed by a user to awaken the hub 300 out of a low power sleep mode, and/or to return the hub 300 to a low power sleep mode. Inclusion of a touch key negates any need for the hub 300 to continuously listen for a verbal command from a user, which in turn reduces the amount of needed processing power of the speech recognition unit 304 and also allows the hub 300 to enter a low power mode when not actually in use.

The hub 300 also includes a wireless communication unit 324, which may be identical or similar to the wireless transceiver 124 described in connection with FIG. 1 above.

The hub 300 communicates wirelessly with a receiver 326. The receiver 326 comprises a wireless communication unit 328, which like wireless communication unit 324, may be identical or similar to the wireless transceiver 124 described in connection with FIG. 1 above. The wireless communication unit 328 receives signals from the wireless communication unit 324, which it passes on to the microcontroller 332. The wireless communication unit 328 also receives signals from the microcontroller 332, which it passes on to the wireless communication unit 324.

The microcontroller 332 may comprise, for example, a processor and a memory, which processor and memory may be the same as or similar to any other processor and memory, respectively, described herein. The microcontroller 332 may be configured to receive one or more signals from the hub 300 via the wireless communication unit 328, and may further be configured to respond to such signals by sending information to the hub 300 via the wireless communication unit 328, and/or to generate a control signal for controlling one or more features of a light 340a, 340b. The microcontroller 332 may also be configured to determine a status of a light 340a, 340b, and to generate a signal corresponding to the status of the light 340a, 340b, which signal may be sent to the hub 300 via the wireless communication unit 328. Still further, the microcontroller 332 may be configured to store information about the one or more lights 340a, 340b, including, for example, information about the features thereof and information about the current status or possible statuses thereof.

The power management unit 336 comprises an internal power source and/or an input for receipt of power from an external power source (e.g. a vehicle battery or vehicle electrical system). The power management unit 336 may be configured to provide substantially the same or similar functions as the power management unit 308, although power management unit 336 may have a different power source than the power management unit 308, and may be configured to transform and/or condition a signal from the power source differently than the power management unit 308. For example, the power management unit 308 may receive power from a vehicle battery or vehicle electrical system, while the power management unit 336 may receive power from one or more 1.5-volt batteries, or from one or more 9-volt batteries. Additionally, the power management unit 336 may be configured to output a power signal having a voltage and current different than the power signal output by the power management unit 308.

The receiver 326 is controllably connected to one or more lights 340a, 340b. The microcontroller 326 generates signals for controlling the lights 340a, 340b, which signals are provided to the lights 340a, 340b to cause an adjustment of a feature of the lights 340a, 340b. In any given vehicle, one receiver may control one lighting device in the vehicle, or a plurality of lighting devices in the vehicle, or all lighting devices in the vehicle. Additionally, when one receiver does not control every lighting devices in the vehicle, additional receivers may be used in connection with each lighting device or group of lighting devices installed in or on the vehicle. The lights 340a, 340b may be any lights or lighting devices installed in or on the vehicle, including for example, internal lights, external lights, headlights, taillights, running lights, fog lamps, accent lights, spotlights, light bars, dome lights, and courtesy lights.

In some embodiments, where a single receiver 326 is connected to a plurality of lights 340a, 340b, a single verbal command (e.g. “Turn on all external lights”) may be used to cause the receiver 326 to send a “turn on” command to all lights 340a, 340b controlled by that receiver 326. Alternatively, where a car uses a plurality of receivers 326 to control a plurality of lights 340a, 340b in and on the vehicle, a single verbal command (e.g. “Turn off all lights”) may be used to cause the hub 300 to send a “turn off” command to each receiver 326, which command may then be provided to each light 340a, 340b attached to each receiver 326. In other embodiments, each light 340a, 340b must be controlled independently, regardless of whether the lights 340a, 340b are connected to the same receiver 326.

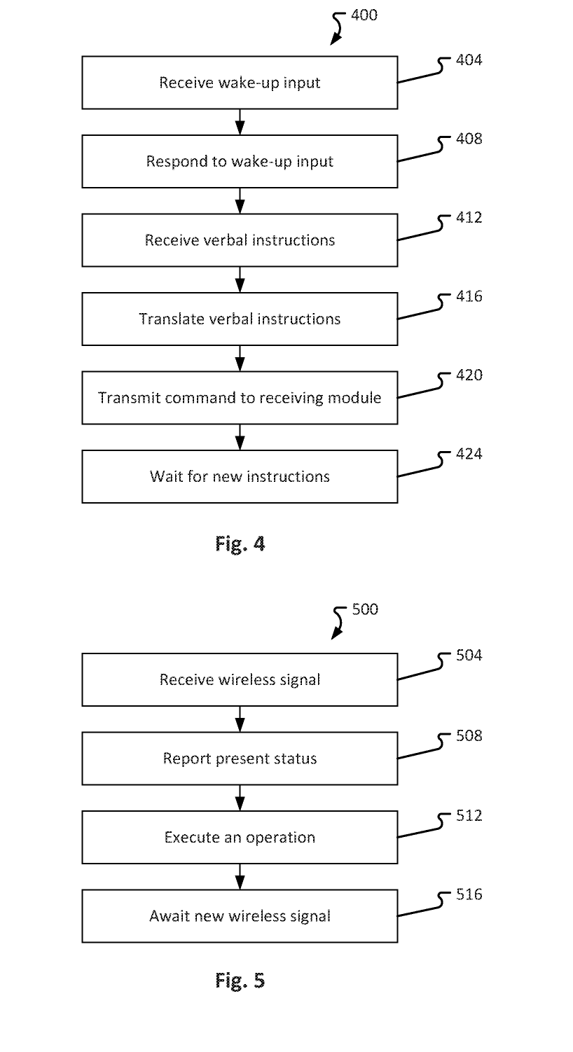

FIGS. 4 and 5 depict methods 400 and 500 according to additional embodiments of the present disclosure. Although the following description of the methods 400 and 500 may refer to the hub 100 or 300 or to the receiver 326 performing one or more steps, persons of ordinary skill in the art will understand that one or more specific components of the hub 100 or 300 or the receiver 326 performs the step(s) in question.

In the method 400, the hub 100 or 300 receives a wake-up or an initial input (step 404). The wake-up input may comprise, for example, a user pressing the touch key 322 of the hub 300 or interacting with the user interface 122 of the hub 100. In some embodiments, the wake-up input may comprise a user speaking a specific verbal command, which may be a name of the hub 100 or of the hub 300 (whether as selected by the manufacturer or as provided by the user), or any other predetermined word or phrase.

The hub 100 or 300 responds to the wake-up input (step 408). The response may comprise requesting a status update of one or more lighting devices from one or more receivers 326, or simply checking the memory 128 or a memory within the speech recognition unit 304 of the hub 300 for a stored status of the one or more lighting devices. Additionally or alternatively, the response may comprise displaying information to the user via the user interface 122 or the LED indicator 320. For example, the hub 100 or 300 may cause an LED light (e.g. the LED indicator 320) to change from red to green as an indication that the wake-up input has been received. Still further, the response may comprise playing a verbal response (e.g. using a computer-generated voice) over the speaker 116 or 316. The verbal response may be a simple indication that that hub 100 or 300 is awake, or that the hub 100 or 300 received the wake-up input. Or, the verbal response may be a question or prompt for a command, such as “yes, master?”.

The hub 100 or 300 receives verbal instructions from the user (step 412). The verbal instructions are received via the microphone 112 of the hub 100 or via the voice acquisition unit 312 of the hub 300. The verbal instructions may be converted into a digital signal and sent to the processor 104 or to the speech recognition unit 304, respectively.

The processor translates or otherwise processes the signal corresponding to the verbal instructions (step 416). The translation or other processing may comprise, for example, decoding the signal to identify a command contained therein, or comparing the signal to each of a plurality of known signals to identify a match, then determining which command is associated with the matching known signal. The translation or other processing may also comprise decoding the signal to obtain a decoded signal, then using the decoded signal to look up an associated command (e.g. using a lookup table stored in the memory 128 or other accessible memory).

The command may be any of a plurality of commands corresponding to operation of a lighting device and/or to operation of the control hub. For example, the command may relate to turning a lighting device on or off; adjusting the color of a lighting device; adjusting a flashing setting of a lighting device; adjusting the position or orientation of a lighting device; or adjusting the intensity or brightness of a lighting device.

The hub 100 or 300 transmits the command to a receiving module, such as the receiver 326 (step 420). The command may be transmitted using any protocol disclosed herein or another suitable protocol. A protocol is suitable for purposes of the present disclosure if it enables the wireless transmission of information (including data and/or commands).

In some embodiments, the hub 100 or 300 may receive from the receiving module, whether before or after transmitting the command to the receiving module, information about the status of the receiving module. This information may be provided to the user by, for example, using a computer-generated voice to convey the information over the speaker 116 or 316. The information may be provided as confirmation that received instructions were carried out, or to provide preliminary information to help a user decide which instruction(s) to issue.

Once the command has been carried out, the hub 100 or 300 awaits new instructions (step 424). The hub 100 or 300 may time-out and enter a low-power sleep mode after a given period of time, or it may stay on until turned off by a user (whether using a verbal instruction or via the user interface 122 or touch key 322). If the hub 100 or 300 does receive new instructions, then the method 400 recommences at step 412 (or 416, once the instructions are received).

The method 500 describes the activity of a receiver 326 according to an embodiment of the present disclosure. The receiver 326 receives a wireless signal (step 504) from the hub 100 or the hub 300. The wireless signal may or may not request information about the present status of one or more lighting devices 340a, 340b attached thereto, but regardless, the receiver 326 may be configured to report the present status of the one or more lighting devices 340a, 340b (step 508). Reporting the present status of the one or more lighting devices 340a, 340b may comprise, for example, querying the lighting devices 340a, 340b, or it may involve querying a memory of the microcontroller 332. The reporting may further comprise generating a signal corresponding to the present status of the lighting devices 340a, 340b, and transmitting the signal to the hub 100 or 300 via the wireless communication unit 328.

The received signal may further comprise instructions to perform an operation, and the receiver 326 may execute the operation at step 512. This may involve using the microcontroller to control one or more of the lighting devices 340a, 340b, whether to turn the one or more of the lighting devices 340a, 340b on or off, or to adjust them in any other way described herein or known in the art.

After executing the operation, the receiver 516 awaits a new wireless signal (step 516). The receiver 326 may enter a low-power sleep mode if a predetermined amount of time passes before a new signal is received, provided that the receiver 326 is equipped to exit the low-power sleep mode upon receipt of a signal (given that the receiver 326, at least in some embodiments, does not include a user interface 122 or touch key 322). If a new wireless signal is received, then the method 500 recommences at step 504 (or step 508, once the signal is received).

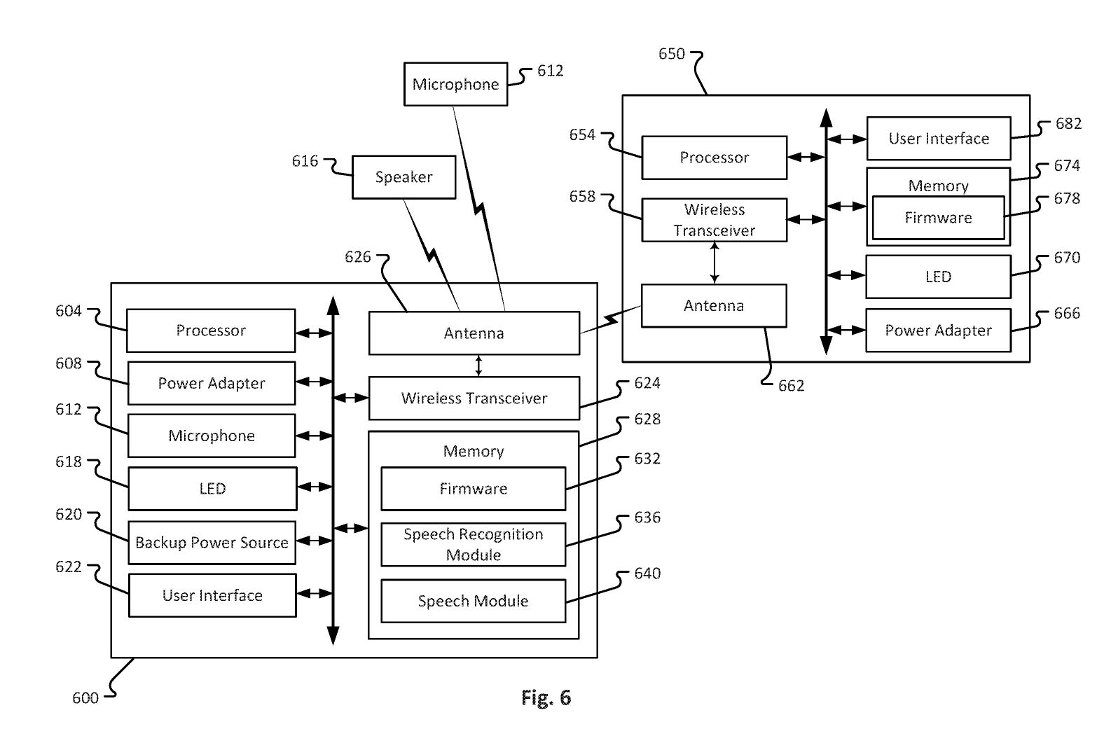

Referring now to FIG. 6, a voice-activated light bulb 600 according to an embodiment of the present disclosure comprises a processor 604, a power adapter 608, a microphone 612, a speaker 616, a light-emitting diode (LED) 618, a backup power source 620, a user interface 622, a wireless transceiver 624 coupled to an antenna 626, and a memory 628. The voice-activated light bulb 600 may be in wireless communication, via the wireless transceiver 624, with one or more of a microphone 612, a speaker 616, and one or more other light bulbs 650. Each light bulb 650 may comprise a processor 654, a wireless transceiver 658 coupled to an antenna 662, a power adapter 666, an LED 670, a memory 674, and a user interface 682.

The processor 604 may be the same as or substantially similar to the processor 104 described above.

The power adapter 608 comprises circuitry for receiving power from an external source, such as a light socket, and accomplishing any signal transformation, conversion or conditioning needed to provide an appropriate power signal to the processor 604 and other components of the voice-activated light bulb 600. For example, the power adapter 608 may comprise one or more AC to DC converters for converting the incoming signal (e.g., an incoming 120-volt, 15-amp alternating current, or a 240-volt, 2.5-amp alternating current, or a 240-volt, 16-amp alternating current, or any other electric signal commonly provided by a third party electrical utility) into a higher or lower voltage as necessary to power the various components of the light bulb 600. Not every component of the light bulb 600 necessarily operates at the same voltage, and if different voltages are necessary, then the power adapter 608 may include a plurality of AC to DC converters or other signal conditioning elements to ensure that each component receives a properly conditioned power signal. In some embodiments, for example, the power adapter 608 may condition the incoming signal to ensure that the power signals being provided to the other components of the light bulb 600 remain within a specific tolerance (e.g. plus or minus 0.5 volts) regardless of fluctuations in the incoming power signal. In some embodiments, the power supply 608 may also include some implementation of surge protection circuitry to protect the components of the hub 600 from power surges.

Particularly for light bulbs 600 adapted to replace existing light bulbs using existing sockets, the power adapter 608 may additionally comprise hardware for securing the light bulb 600 to a light socket. In such light bulbs 600, the various components of the light bulb 600 may be contained in a housing, which may comprise transparent portions, translucent portions, and/or opaque portions. The housing may be bulb-shaped. The housing may comprise a base comprising external threads and adapted to be screwed into a standard light socket. The power adapter 608 may utilize the base to receive electricity from the light socket. For example, in a power adapter 608 with a threaded base, the threaded base may be made of an electrically conducting material and comprise a first contact, and a second contact, electrically insulated from the first contact, may be positioned at a foot of the housing (e.g. at a bottom of the base).

In some embodiments, the power adapter 608 also controls the flow of power to the LED 618 within the light bulb 600. For example, the power adapter 608 may be configured to adjust the flow of electricity to the LED 618 to control the brightness or color thereof. In other embodiments, the power adapter 608 may be configured to simply pass an unconditioned power signal received from an outside source directly to the LED 618.

The microphone 612 is used to receive verbal commands regarding control of the light bulb 600, and more particularly of the LED 618. The microphone 612 may be any type of microphone suitable for detecting and recording verbal commands. In some embodiments, such as for a light bulb 600 that is intended for use in an environment with high ambient noise, the microphone 612 may be equipped with one or more physical or electronic filters for filtering out such ambient noise. The microphone 612 may be, for example, an electret microphone. The microphone 612 may also be a cardioid or other directional microphone, for limiting the detection of unwanted noise. The microphone 612 may comprise noise-cancelling or noise-filtering features, for cancelling or filtering out noises that may be present during use, including heating/air conditioning noises, background music noise, background conversation noise, and weather noise (e.g. noise caused by falling rain, wind, thunder, or other weather phenomena). In some embodiments, the light bulb 600 may comprise a plurality of microphones 612, which may result in an improved ability to pick up verbal commands and/or to filter out unwanted noise.

In some embodiments, the microphone 612 is contained within or mounted to a housing of the light bulb 600. In other embodiments, such as when the light bulb 600 is intended for use in a light fixture that is high off the ground (e.g. in a gymnasium or auditorium) or that is located in a place where a user of the light bulb 600 may be unable to provide distinguishable verbal commands for control thereof (e.g. light bulbs in a noisy restaurant or other commercial establishment), the microphone 612 (or an additional microphone 612) may be external to and separate from the light bulb 600, and connected thereto via a wireless connection. For example, the light bulb 600 may be configured to pair with an external microphone 612 using the wireless transceiver 624, via a wireless communication protocol such as Wi-Fi, Bluetooth®, Bluetooth Low Energy (BLE), ZigBee, MiWi, FeliCa, Weigand, or a cellular telephone interface. In this way, the microphone 612 may be positioned in a location that is quieter or otherwise more accessible to a user of the light bulb 600, and/or where the light bulb 600 can more readily detect verbal commands uttered by the user.

In some embodiments of the present disclosure, a voice-activated light bulb 600 may constantly record and analyze audio received via the microphone 612. In such embodiments, the light bulb 600 may be programmed to analyze the incoming audio stream for a specific name or other identifier of the light bulb 600, or to recognize a specific word or phrase (or one of a plurality of specific words of phrases) as indicative that a command will follow. The specific word or phrase may be, for example, simply “Lights,” or it may be a location in which the light bulb 600 is installed, such as “Bedroom Light.” The word or phrase may be preprogrammed (e.g. upon manufacture of the light bulb 600), or it may be programmable by the owner or end-user. The word or phrase may be a name assigned to the light bulb 600 (whether that name is assigned by the manufacturer or chosen by an owner or user). When the light bulb 600 continuously analyzes incoming audio, the light bulb 600 may continuously record incoming audio (which may be discarded or recorded over once the audio has been analyzed and found not to include a name or other identifier or command, or once a provided command has been executed), or may record audio only when a word or phrase trigger is detected.

Some embodiments of the light bulb 600 are equipped to wirelessly communicate with a speaker 616. The wireless transceiver 624, for example, may be used to connect the light bulb 600 to a speaker 616, using a wireless communication protocol such as Wi-Fi, Bluetooth®, Bluetooth Low Energy (BLE), ZigBee, MiWi, FeliCa, Weigand, or a cellular telephone interface. Alternatively, the speaker 616 may be provided within the light bulb 600. Regardless of whether the speaker 616 is external to or within the light bulb 600, the speaker 616, when used with the light bulb 600, is used to provide information to a user of the light bulb 600. For example, if a user requests a status update regarding some aspect of the operation of the light bulb 600, the light bulb 600 may transmit a signal via the wireless transceiver 624 to a speaker 616 that causes the requested information to be spoken to the user by a computer-generated voice via the speaker 116. Additionally, the light bulb 600 may be configured to interact with a user via a speaker 616. The light bulb 600 may, for example, query the user via the speaker 616, in much the same way that the hubs 100 and 300 query a user thereof, as described above.

The LED 618 may comprise one or more LEDs, and in some embodiments may comprise a light-emitting device other than an LED. The LED 618 may be capable of emitting light at a plurality of frequencies corresponding to different colors. This capability may result from the inclusion in the LED 618 of a plurality of LEDs, each capable of emitting light of a different color, such that by adjusting the brightness of each LED, the color of the emitted light may be changed. The LED 618 may also have a controllably adjustable brightness, such that the LED 618 is dimmable.

Also in some embodiments, the voice-activated light bulb 600 may comprise a backup power source 620. The backup power source 620 may be, for example, one or more batteries (e.g. AAA batteries, lithium ion batteries, button cell batteries). The backup power source 620 may be used to power the light bulb 600 if an external power source fails. The backup power source 620 may also be used to power the light bulb 600 during initial setup, which may occur before the light bulb 600 is installed in a powered light socket. Initial setup may comprise, for example (but is not limited to) assigning a name or other identifier to the light bulb 600; pairing the light bulb 600 with a wireless speaker 616; recording specific voice commands and assigning them to specific actions; and recording certain words or sounds so that the processor 604 can better interpret commands spoken by the end-user.

A user interface 622 may also be provided with the light bulb 600. The user interface 122 may be in the form of a simple button or switch, configured to receive an input. Such a simple button or switch is, beneficially, unlikely to occupy much space in or on the light bulb 600, in which little space is available in the first place. In some embodiments, the user interface 122 may comprise an input device (e.g. a button or switch) coupled with the LED 618, which may be configured to illuminate in one or more predetermined sequences in response to certain inputs provided via the input device. Because the light bulb 600 will typically be relatively inaccessible during normal use, the user interface 622 may be used for pre-installation setup of the light bulb 600. For example, the user interface 622 may be used for pairing the light bulb 600 with other light bulbs that may be controlled by the light bulb 600, and/or for recording voice commands spoken by the end user of the light bulb 600, which voice commands may be analyzed to enable to the light bulb 600 to better understand the voice commands once the light bulb 600 is installed. In some embodiments, a user may depress a button of the user interface 622 in a predetermined sequence to cause the processor 604 to execute instructions that cause the light bulb 600 to store in the memory 628 data corresponding to a vocal command spoken by the user into the microphone 612, and to associate the recorded data with a particular action. Also in some embodiments, the processor 604 may execute instructions stored in the speech recognition module 636 that cause the processor 604 to analyze the data stored in the memory 628 so as to be able to better interpret commands spoken by the user despite any unique characteristics of the user's voice (whether in accent, tone, pitch, or any other speaking characteristic).

The wireless transceiver 624 comprises hardware that allows the light bulb 600 to transmit commands and data to one or more other light bulbs 650 that are intended to be operated simultaneously with the light bulb 600 and under the control of the light bulb 600. In some embodiments, the wireless transceiver 624 may also receive signals from a remote microphone 612, and in some embodiments the wireless transceiver 624 may transmit signals to a remote speaker 616, as described above. The wireless transceiver 624 may comprise a Wi-Fi card, a Network Interface Card (NIC), a cellular interface (e.g., antenna, filters, and associated circuitry), an NFC interface, an RFID interface, a ZigBee interface, a FeliCa interface, a MiWi interface, Bluetooth interface, a BLE interface, or the like.

The memory 628 may correspond to any type of non-transitory computer-readable medium. In some embodiments, the memory 628 may comprise volatile or non-volatile memory and a controller for the same. Non-limiting examples of memory 628 that may be utilized in the light bulb 600 include RAM, ROM, buffer memory, flash memory, solid-state memory, or variants thereof.

The memory 628 stores any firmware 632 needed for allowing the processor 604 to operate and/or communicate with the various components of the light bulb 600, as needed. The firmware 632 may also comprise drivers for one or more of the components of the light bulb 600. In addition, the memory 628 stores a speech recognition module 636 comprising data and instructions that, when executed by the processor 604, allow the processor 604 to recognize one or more commands in an audio segment recorded via the microphone 612, which commands can then be carried out by the processor 604. In some embodiments, the memory 628 may store a speech module 640 comprising instructions that, when executed by the processor 604, allow the processor 604 to provide spoken information to an operator of the light bulb 600 via an external speaker 616. The memory 628 may be used for the storage of any data needing to be stored, including, for example, recordings of vocal commands spoken by a user of the light bulb 600, and look-up tables for correlating spoken commands with specific actions.

The light bulb 650 comprises several components that may be the same as or similar to the components of the light bulb 600. While the light bulb 600 is configured to receive and respond to voice commands, the light bulb 650 is configured only to receive commands from a light bulb 600, and to execute such commands. In this manner, a voice command may be given to a light bulb 600, which can then wirelessly transmit a corresponding command to one or more light bulbs 650 to effect a change in the lighting of an entire room or space.

Like the processors 604, the processor 654 may be the same as or substantially similar to the processor 104 described above.

The wireless transceiver 658 comprises hardware that allows the light bulb 650 to receive commands and/or data from a light bulb 600. The wireless transceiver 658 may also be used to relay commands from the light bulb 600 to other light bulbs 650, so as to extend the range of control of the light bulb 600. In some embodiments, the wireless transceiver 624 may also be configured to relay signals from a remote microphone 612 to the light bulb 600, and/or to relay signals from the light bulb 600 to a remote speaker 616, as described above. The wireless transceiver 624 may comprise a Wi-Fi card, a Network Interface Card (NIC), a cellular interface (e.g., antenna, filters, and associated circuitry), an NFC interface, an RFID interface, a ZigBee interface, a FeliCa interface, a MiWi interface, Bluetooth interface, a BLE interface, or the like.

In some embodiments, a light bulb 650 may be equipped only with a wireless receiver, rather than with a wireless transceiver. In such embodiments, the light bulb 650 receives commands from a light bulb 600, but does not relay any such commands to any other light bulbs 650, and also does not relay other signals that might be received by the light bulb 650, or transmit any signal generated by the processor 654.

The antenna 662 may be the same as or substantially similar to the antenna 626.

The power adapter 666 may be the same as or substantially similar to the power adapter 608.

The LED 670 may be the same as or substantially similar to the LED 618.

The memory 674 stores any firmware 678 needed for allowing the processor 654 to operate and/or communicate with the various components of the light bulb 650, as needed. The firmware 678 may also comprise drivers for one or more of the components of the light bulb 650. The memory 674 also stores any data or other instructions needed for operation of the light bulb 650.

The user interface 682 may be the same as or substantially similar to the user interface 622.

As indicated above, the light bulb 600 is programmed or otherwise configured to receive and respond to audio commands. An audio command may include (1) an identification of the light bulb 600 having a state that the commanding user would like to change; and (2) an identification of the change the user would like to make. This two-pronged format may not be needed or utilized where only one light bulb 600 is in use, and/or where the light bulb 600 in question has only two possible states (e.g. on/off). However, if for example a plurality of light bulbs 600 are being used within a given building or other space (such that a plurality of light bulbs 600 are likely to detect a spoken command with their respective microphones 612), and/or one or more of the light bulbs 600 may be controlled in more ways than just being turned on and off, the two-pronged format for audio commands may be useful or even necessary.

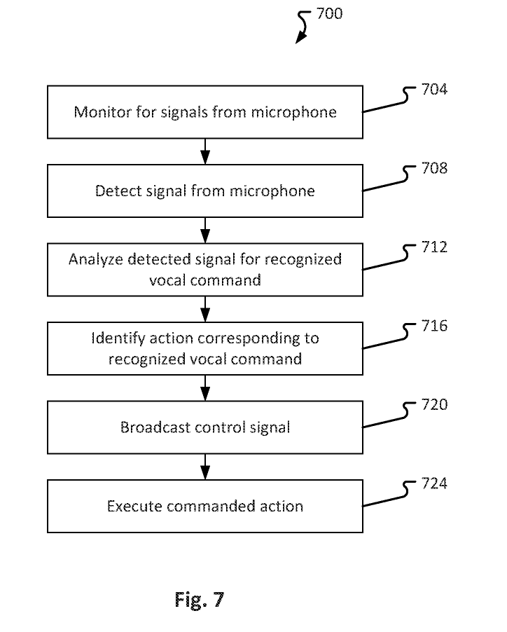

With reference now to FIG. 7, a voice-activated light bulb 600 according to the present disclosure may be operated according to a method 700. In the following description of the method 700, reference may be made to actions or steps carried out by the light bulb 600, even though the action or step is carried out only by a specific component of the light bulb 600. Persons of ordinary skill in the art will understand which component or components of the light bulb 600 may carry out each action or step.

Once the light bulb 600 has been installed in a light socket and the light socket is provided with power (e.g. by turning on a light switch, if the light socket is controlled by a light switch), the various components of the light bulb 600 are automatically powered via the power adapter 608. At step 704, the light bulb 600 enters a ready state in which the processor 604 monitors for signals received at the processor 604 from the microphone 612.

At step 708, the processor 604 detects a signal from the microphone 612. In some embodiments, the microphone 612 and/or the processor 604 may be equipped to filter out any signal that does not surpass a minimum volume/amplitude threshold, or to otherwise filter the output of the microphone 612. Such embodiments may beneficially avoid a situation in which the processor 604 is constantly detecting (and analyzing, in step 712) background noise, thus both wasting energy and wearing out the processor 604. The microphone 612 and any filters used to condition the output of the microphone 612 may be selected and/or configured to improve the ability of the light bulb 600 to identify actual vocal commands while disregarding other sounds and noise.

At step 712, the processor 604 analyzes the detected signal to determine, first, whether the detected signal corresponds to a recognized vocal command, and second, if so, which specific vocal command has been received. This may be accomplished by the processor 604 executing instructions stored in the speech recognition module 636, which instructions may allow the processor 604 to translate or otherwise process the received command into computer-readable data. In this manner, the processor 604 may extract speech information from the received command, translate that information into computer readable data, and then compare the computer readable data with stored speech information (also in the form of computer-readable data) corresponding to one or more predetermined vocal commands. In other embodiments, the processor 604 may compare a received vocal command to a set of prerecorded or preprogrammed vocal commands spoken by the end user of the light bulb 600 during a set-up process and stored in the memory 628.

Regardless of how the analysis occurs, once the processor 604 identifies a match or correlation between a detected signal or information contained therein and a recognized vocal command, the processor 624 identifies the action associated with the vocal command in step 716. In some embodiments, a look-up table includes each vocal command and the corresponding action, and the processor 624 uses the look-up table to determine which action to perform once a particular vocal command is recognized. Such a look-up table may be stored in the memory 628, and may comprise part of the speech recognition module 636. In other embodiments, the speech recognition module 636 may be configured to translate vocal commands directly into instructions that, when provided to and executed by the processor 624, cause the desired action to occur.

Various actions may be associated with a vocal command, all of which relate to the LED 618. In the simplest embodiments, the actions may be (1) turn on the LED 618; and (2) turn off the LED 618. In more complex embodiments, additional actions may include (3) adjusting the brightness of the LED 618 (e.g. by dimming or brightening the LED 618); (4) changing the color of the LED 618, whether randomly or to a specified color; (5) causing the LED 618 to flash in a predetermined sequence, or pulse to a beat (e.g. to the beat of music, as detected via the microphone 612); (6) causing the LED 618 to illuminate for a specified amount of time; (7) causing the light bulb 600 to control one or more other light bulbs 650, in any of the ways identified above (e.g. turning the light bulbs 650 on or off, dimming or brightening the light bulbs 650, changing the color of the lights bulbs 650, causing the light bulbs 650 to flash, or to pulse to a beat); and (8) causing the light bulb 600 to determine and/or report a status of the LED 618 of the light bulb 600, or of the LED 670 of one or more light bulbs 650, or of the LED 618 of another light bulb 600.

In step 720, the processor 624 broadcasts a control signal, via the wireless transceiver 624, for controlling any light bulbs 650 associated with the light bulb 600 and within range of the wireless transceiver 624. In embodiments where the light bulbs 650 are not specifically associated with any one light bulb 600, any light bulb 650 that receives the control signal will carry out the action commanded by the control signal. In embodiments where one or more light bulbs 650 are specifically associated with one light bulb 600, the associated light bulbs 650 will receive the signal and verify that it was sent by the associated light bulb 600 before carrying out the action commanded by the control signal. In both instances, the light bulbs 650 may rebroadcast the control signal via their respective wireless transceivers 658 to help ensure that all light bulbs 650 that are intended to receive the control signal do receive the control signal.

Also in some embodiments, the processor 624 may cause the wireless transceiver 624 to transmit a control signal to a specific light bulb 650. For example, the processor 624 may add (based on identification information provided by a user of the light bulb 600, such as a spoke identifier or name of the light bulb 650) identification information for the light bulb 650 to the control signal that identifies the specific light bulb 650 to execute the action. Alternatively, the light bulb 600 may engage in an authentication process with a light bulb 650, whereby the light bulb 600 and the light bulb 650 establish a communication channel (whether secure or not) over which the command signal is transmitted from the light bulb 600 to the light bulb 650.

In step 724, the light bulb 600 executes the action associated with the detected vocal command. In some embodiments, the light bulb 600 may delay the action slightly to allow time for any light bulbs 650 to receive the command signal transmitted by the light bulb 600, so as to increase the likelihood that all of the light bulbs 600 and 650 will execute the commanded action in unison. In other embodiments, the light bulb 600 may execute the action immediately, without regarding for whether any light bulbs 650 will execute the commanded action simultaneously. Also in some embodiments, the light bulb 600 may transmit a specific time at which to execute the action, or a specific period of time for which each light bulb 650 and the light bulb 600 should wait before executing the action.

Once the light bulb 600 has executed the commanded action, the light bulb 600 returns to a ready state and awaits another command.

In some embodiments, an end user may have a plurality of light bulbs 600 installed in his or her home, office, or other space. For example, each room of a house may be equipped with at least one light bulb 600. In rooms with more than one light fixture, or with a light fixture configured with a plurality of light sockets, one or more light bulbs 650 may also be provided. Proper control of the light bulbs 600 and 650 in such embodiments may require the additional aspects of the present disclosure described below.

In some embodiments, the light bulb 600 may be provided with an identifier that must be spoken or otherwise uttered in conjunction with a vocal command in order for the light bulb 600 to detect the command. In these embodiments, when the light bulb 600 detects a signal from the microphone 612 and analyzes the signal to determine whether the signal includes a vocal command, the light bulb 600 also analyzes the signal to determine whether the signal includes the identifier of the light bulb 600. If so, the light bulb 600 responds to the command. If not, then the light bulb 600 ignores the command. Alternatively, the light bulb 600 may relay such commands by broadcasting the command via the wireless transceiver 624. One or more light bulbs 650 may receive the relayed command and broadcast it yet again. Each light bulb 600 that receives the relayed command may determine whether the signal includes the identifier of that particular light bulb 600, and once the relayed command reaches the light bulb 600 that does correspond to the identifier in the command, that light bulb 600 may further process the received command and execute the commanded action. In this way, the light bulbs 600 may act as a network of microphones 612 that allows a user in one part of a house, office, or other space to control the lighting in a distant part of the house, office, or other space.

Alternatively, in embodiments where the light bulbs 600 share information with each other, a user may make select a specific light bulb 600 by speaking the name or other identifier associated with the light bulb 600 within detection range of the microphone 612 of any light bulb 600 in the network of light bulbs 600. For example, the light bulbs 600 may be named by location, and a user wishing to change the kitchen or loft lighting might begin a command by saying “kitchen” or “loft.” In other embodiments, the user might simply incorporate the name of the appropriate light bulb 600 into a spoken command, not necessarily at the beginning: “Turn on the lights in the kitchen” or “Dim the lights in the loft.” In these embodiments, the identified light bulb 600 may, after receiving the command and executing the commanded action, send a confirmation signal back to the originating light bulb 600 whose microphone 612 picked up the initial command, which originating light bulb 600 may provide a confirmation to the user. The confirmation may be, for example, a flash or pulse of the LED 618 of the light bulb 600, or transmission by the light bulb 600 of a signal to a speaker 616 that causes the speaker 616 to play a verbal confirmation that the command has been carried out. A user may be able to configure the light bulb 600 to provide such a confirmation by flashing the LED 618, playing a verbal confirmation over a speaker 616, or in another convenient way.

In still other embodiments, a plurality of light bulbs 600 may communicate with each other via the wireless transceivers 624 thereof, such that a command received via the microphone 612 of one light bulb 600 may be transmitted to every other light bulb 600 for execution thereby. For example, in home having one or more light bulbs 600 in each room thereof, a user may speak a command in one room, which command may be detected by a microphone 612 of a light bulb 600 in the one room. That light bulb 600 may both execute the command and transmit the command to every other light bulb 600 within communication range of the wireless transceiver 624 thereof, and each light bulb that receives the command may also execute the command. In some embodiments, each light bulb that receives the command may further rebroadcast or retransmit the command, to ensure that all light bulbs 600 in the house receive and execute the command. In this manner, all light bulbs 600 in a given network of light bulbs 600 may be controlled by any one of the light bulbs 600.

In a network of light bulbs 600, each light bulb 600 may store, in a memory 628 thereof, a set of command deconfliction rules (as a set of instructions for execution by the processor 604 thereof). These command deconfliction rules may be used to ensure that a light bulb 600 that both receives a command via the microphone 612 thereof and receives a command via the wireless transceiver 624 thereof (e.g. from another light bulb 600) executes the proper command. Such rules may provide, for example, that a transmitted command (e.g. a command receives via the wireless transceiver 624) takes precedence over an uttered command received via the microphone 612, or vice versa. In some embodiments, the instructions may cause the processor to compare the spoken command and the transmitted command, and to proceed with execution thereof only if the commands match. Also in some embodiments, each command transmitted via a wireless transceiver 624 of a light bulb 600 may comprise a time stamp of the time of transmission, and each light bulb 600 may be configured to execute only one command received via the wireless transceiver 624 in any predetermined period of time (e.g. one second, or three seconds, or five seconds, or ten seconds), unless a subsequently received command has an earlier timestamp than the earlier received and/or executed command. In this manner, if multiple light bulbs 600 detect a spoken command via their respective microphones 612 and transmit a corresponding signal or command via their respective wireless transceivers 624, the light bulbs 600 in the network will execute the first transmitted command, thus maintaining uniformity among the light bulbs 600. Alternatively, each transmitted command may include a decibel level of a detected vocal command, and the transmitted command with the highest decibel level (which may be assumed to originate from the light bulb 600 closest to the user) may have priority over all other transmitted commands. As still another alternative, each light bulb 600 that detects a vocal command may assign a confidence level to its interpretation of the command, and include the confidence level in a subsequently transmitted command. In such embodiments, the transmitted command with the highest confidence level may have priority over all other commands. This alternative may beneficially allow a command transmitted from a light bulb 600 that is farther from the user 600 than other light bulbs 600, but that detects vocal command of the user more clearly, to have the highest priority for execution.

Further with respect to a network of light bulbs 600, the light bulbs 600 in such a network may be divided into groups, and each group may be given a name or other identifier (e.g. loft, master bedroom, master bath, living room, dining room, kitchen, basement). In such embodiments, a user may speak a command within detection range of any light bulb 600 in the network of light bulbs 600, together with the name or identifier of the group of light bulbs 600 that the user would like to control. This command may then be transmitted to the other light bulbs 600 in the network as described above, but only those light bulbs 600 having the name or identifier that matches the spoken name or identifier will execute the command. In some embodiments, multiple layers of groups may be established. For example, a given light bulb 600 in a kitchen located in the east wing of the main level of a home may be assigned to the groups “main level,” “east wing,” and “kitchen.” This light bulb 600 would then respond to any command that includes any one of these names or identifiers. In this way, a user can control all light bulbs 600 on the main level, or all light bulbs 600 in the east wing, or all light bulbs 600 in the kitchen.

Also, a user may simply request the status of a particular light bulb 600 in a network of light bulbs 600 (by stating in the presence of any one of the light bulbs 600 in the network, for example, “loft status”), which request may result in a status request signal being sent to the identified light bulb 600, a status signal being sent from the identified light bulb 600 to the originating light bulb 600, and some sort of indication to the user of the status of the identified light bulb. Here again, the indication to the user may be a flash or sequence of flashes or pulse of the LED 618 of the originating light bulb 600, or a verbal statement of the status played by a speaker 616 as a result of a signal transmitted to the speaker 616 from the originating light bulb 600.

In some embodiments, light bulbs 600 may be configured to recognize and respond to general commands, such as “lights on” or “lights off.” These commands may be executed by all light bulbs 600 that receive the command, even if the light bulbs 600 would normally only execute a command that included a name or other identifier of the light bulb 600 in question.

Also in some embodiments, simply speaking the name or other identifier of a light bulb 600 may cause the light bulb 600 to turn the LED 618 from on to off or from off to on, depending on whether the LED 618 is on or off when the name is spoken. In these embodiments, a user can provide a further command if desired (e.g. “loft lights change color” or “bedroom lights beat to music”), but need not speak a full command for basic tasks such as turning lights on or off. Of course, in such embodiments, when the LED 618 of a light bulb 600 is already on, and a user provides a full command for that light bulb 600, the light bulb 600 will not turn off the LED 618, but will instead execute the action associated with the provided command.

Although described above in the context of a network of light bulbs 600, the foregoing concepts may also be utilized with just one light bulb 600. For example, a user may be required to speak a name or other identifier of the light bulb 600 to cause the light bulb 600 to recognize an associated command. The name or other identifier may be required to be spoken before the command or as part of the command. The light bulb 600 may acknowledge the command by flashing its LED 618 or by causing a verbal confirmation to be played via a speaker 616. In some embodiments, a light bulb 600 may be configured to flash its LED 618 when it detects an audio signal corresponding to its name or other identifier, as an indication that the name or other identifier was recognized and/or that the light bulb 600 is ready to receive a command. A single light bulb 600 may also be configured to respond to a general command (e.g. “lights on” or “lights off”), and/or to respond to detection of the name or identifier of the light bulb 600 by turning the LED 618 from on to off or vice versa, as appropriate.

In some embodiments a light bulb 650 may be provided within wireless transmission range of the wireless transceiver 624 of a plurality of light bulbs 600. For example, a house may have a plurality of rooms, each provided with a light bulb 600 and one or more light bulbs 650, and the owner of the house may desire that lighting in each of the rooms is controlled independently. However, the light bulbs 650 in one room may be within wireless communication range not only of a light bulb 600 from the one room, but also of one or more light bulbs 600 from one or more adjacent rooms. In such embodiments, to prevent the light bulbs 650 from responding to every command transmitted by each one of the plurality of light bulbs 600, the light bulbs 650 must be paired or otherwise synced to or associated with just one of the light bulbs 600. While such pairing/syncing/associating may be accomplished in any way known in the art, in some embodiments the pairing is accomplished by simultaneously depressing a button of the user interface 622 and a button of the user interface 682, which may cause the processor 624 to transmit a signal via the wireless transceiver 624, and may further cause the processor 652 to receive the transmitted signal via the wireless transceiver 658 and extract therefrom identification information about the light bulb 600 that transmitted the signal. Then, each time the light bulb 650 receives a wireless signal from a light bulb 600, the processor 654 may analyze the signal to determine whether the signal includes identification information corresponding to the same light bulb 600, and may execute any command included in the signal only if such a correspondence does in fact exist. Other methods of pairing or otherwise establishing a link or a communication channel between a light bulb 600 and a light bulb 650 may be used, including any method of pairing, linking or establishing a communication channel between two electronic devices that is known in the art.

In embodiments of the light bulb 600 that utilize an external speaker 616, the method 700 may be modified to include additional steps for providing feedback to the user via the speaker 616, in much the same way that the speaker 116 is used to provide feedback to the user of the hub 100. For example, the speaker 616 may be used to request a command when the light bulb 600 is first powered on; to confirm that a detected command was properly interpreted; to seek clarification of a command; to present available commands to the user; to provide a status of a light bulb 600 to the user; and/or to provide a list of options associated with a specific light bulb 600 to a user.

It should be appreciated that aspects of the foregoing disclosure regarding the hubs 100 and 300, as well as the lighting devices controlled by the hubs 100 and 300, are applicable to the design and operation of the light bulbs 600 and 650. As just one example, one or more components of the hubs 100 and 300 may be used in the light bulbs 600, which light bulbs 600 may also carry out one or more steps of the methods 200, 400, and 500. More specifically, and by way of example only, a voice-activated light bulb according to embodiments of the present disclosure may comprise a voice acquisition unit comprising a microphone (similar or identical to the voice acquisition unit 312), a speech recognition unit comprising a processor and a computer-readable memory storing instructions for execution by the processor (similar or identical to the speech recognition unit 304); a wireless communication unit for communication with one or more light bulbs 650 (similar or identical to the wireless communication unit 324), and a power management unit configured to provide power to at least the speech recognition unit (similar or identical to the power management unit 308). The instructions stored in the computer-readable memory, when executed by the processor, may cause the processor to detect a verbal command received via the microphone, identify an action associated with the verbal command, and carry out the action (which may include, for example, causing one or more LEDs to turn on or off or to otherwise selectively illuminate the one or more LEDs).

Further, the light bulbs 650 may include one or more of the same or similar components as the receiver 326, and may also carry out one or more steps of the methods 200, 400, and 500. Thus, although certain embodiments of the light bulbs 600 and 650 have been described above, other embodiments using various combinations of the features and aspects described herein (including features and aspects described with respect to FIGS. 1-5) are also included within the scope of the present disclosure.

It should be appreciated that the embodiments of the present disclosure need not be connected to the Internet or another wide-area network to conduct speech recognition or other functions described herein. The hubs 100 and 300 and the light bulb 600 have stored in a computer-readable memory therein the data and instructions necessary to recognize and process verbal instructions.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARIVI926EJS™ processors. A processor as disclosed herein may perform computational functions using any known or future-developed standard, instruction set, libraries, and/or architecture.

I claim:

1. A voice-activated light bulb, comprising:
a light-emitting device;
a processor;
a microphone;
a power adapter; and
a memory, the memory storing instructions for execution by the processor that, when executed by the processor, cause the processor to:
detect a signal received from the microphone;
analyze the detected signal to extract a vocal command;
identify an action associated with the vocal command, the action related to the light-emitting device; and
execute the action.

2. The voice-activated light bulb of claim 1, further comprising a physical user interface.

3. The voice-activated light bulb of claim 2, wherein the memory stores additional instructions for execution by the processor that, when executed by the processor, further cause the processor to:
detect an input received at the physical user interface; and
execute at least one additional instruction corresponding to the detected input.

4. The voice-activated light bulb of claim 1, further comprising a wireless transceiver.

5. The voice-activated light bulb of claim 4, wherein the memory stores additional instructions for execution by the processor that, when executed by the processor, further cause the processor to:
broadcast a signal, via the wireless transceiver, corresponding to the identified action.

6. The voice-activated light bulb of claim 1, further comprising at least one filter configured to remove unwanted frequency components from the signal received from the microphone.

7. The voice-activated light bulb of claim 1, wherein the light-emitting device comprises at least one LED.

8. The voice-activated light bulb of claim 1, wherein the action comprises one of turning on the light-emitting device, turning off the light-emitting device, dimming the light-emitting device, brightening the light-emitting device, causing the light-emitting device to illuminate for a specified amount of time, causing a change in a color of light emitted by the light-emitting device, causing the light-emitting device to flash in a predetermined sequence, and causing the light-emitting device to pulse to a beat.

9. A voice-controlled lighting system comprising:
at least one controllable light bulb, comprising:
a first light-emitting device;
a first processor;
a first wireless transceiver; and
a first memory, the first memory storing first instructions for execution by the first processor; and
a voice-controlled light bulb comprising:
a second light-emitting device;
a second processor;
a microphone;
a second wireless transceiver; and
a second memory, the second memory storing second instructions for execution by the second processor that, when executed by the second processor, cause the second processor to:
detect a signal received from the microphone;
analyze the detected signal to extract a vocal command;
identify an action associated with the vocal command;
transmit a signal, via the second wireless transceiver, to the at least one controllable light bulb, the signal corresponding to the identified action; and
execute the action.

10. The voice-controlled system of claim 9, wherein the first instructions, when executed by the first processor, cause the first processor to:
receive the transmitted signal from the voice-controlled light bulb via the first wireless transceiver;
determine the action to which the broadcast signal corresponds; and
execute the action.

11. The voice-controlled lighting system of claim 9, wherein the at least one controllable light bulb comprises a first user interface and the voice-controlled light bulb comprises a second user interface, each of the first and second user interfaces comprising a physical button or switch.

12. The voice-controlled lighting system of claim 11, wherein simultaneous activation of the first user interface and the second user interface causes at least one of the first processor and the second processor to execute instructions for establishing a communication channel between the controllable light bulb and the voice-controlled light bulb.

13. The voice-controlled lighting system of claim 9, wherein at least one of the first and second light emitting devices comprises at least one LED.

14. The voice-controlled lighting system of claim 13, where the at least one of the first and second light emitting devices comprises a plurality of LEDs, the plurality of LEDs comprising LEDs of different colors.

15. The voice-controlled lighting system of claim 9, wherein the first memory stores additional first instructions for execution by the first processor that, when executed by the first processor, further cause the first processor to:
transmit a confirmation signal to the voice-controlled light bulb via the first wireless transceiver, the confirmation signal confirming that the action was executed.

16. A light bulb, comprising:
a housing comprising at least one transparent or translucent portion, the housing containing:
a light-emitting device configured to emit light through the at least one transparent or translucent portion;
a microphone;
a processor; and
a memory storing instructions for execution by the processor, the instructions, when executed by the processor, causing the processor to:
detect a signal received from the microphone;
analyze the detected signal to extract a vocal command;
identify an action associated with the vocal command; and
execute the action; and
a base secured to a bottom portion of the housing, the base comprising external threads and adapted to secure the housing to a standard light socket.

17. The light bulb of claim 16, wherein the housing further contains a wireless transceiver, and the memory stores additional instructions for execution by the processor that, when executed by the processor, further cause the processor to:
broadcast a signal corresponding to the identified action via the wireless transceiver.

18. The light bulb of claim 16, wherein the housing further contains a wireless transceiver, and the memory stores additional instructions for execution by the processor that, when executed by the processor, further cause the processor to:
transmit a signal, via the wireless transceiver, for causing an external speaker to provide verbal feedback regarding the vocal command or the action.

19. The light bulb of claim 16, wherein the housing further contains a wireless transceiver, and the memory stores additional instructions for execution by the processor that, when executed by the processor, further cause the processor to:
receive a transmitted command via the wireless transceiver; and
execute the transmitted command.

20. The light bulb of claim 19, wherein the memory stores additional instructions for execution by the processor that, when executed by the processor, further cause the processor to:
receive a plurality of transmitted commands via the wireless transceiver;
compare at least a portion of the plurality of transmitted commands to each other;
identify, based on the comparison, one of the plurality of transmitted commands that has priority over the remainder of the plurality of transmitted commands; and
execute the identified one of the plurality of transmitted commands.
